(19) United States
(12) Patent Application Publication
(10) Pub. No.: US 2013/0188495 A1
(43) Pub. Date: Jul. 25, 2013

(54) Apparatus and Method for Communication

(71) Applicants: Jari ISOKANGAS, Tampere (FI); Jukka Ranta, Kaarina (FI)

(72) Inventors: Jari ISOKANGAS, Tampere (FI); Jukka Ranta, Kaarina (FI)

(73) Assignee: Renesas Mobile Corporation

(21) Appl. No.: 13/364,468

(22) Filed: Feb. 2, 2012

(30) Foreign Application Priority Data
Jan. 23, 2012 (GB) 1201051.8

(51) Int. Cl. H04W 52/02; H04W 24/00

(52) U.S. Cl. 370/241; 370/328; 370/311

(57) ABSTRACT

Apparatus and method for communication are provided. The solution includes executing one or more applications, which generate data traffic with the system; obtaining traffic profiles of the one or more applications and controlling the transmission of information related to the traffic profiles to the communication system.

### FIELD

The exemplary and non-limiting embodiments of the invention relate generally to wireless communication networks. Embodiments of the invention relate especially to an apparatus and a method in communication networks.

### BACKGROUND

The following description of background art may include insights, discoveries, understandings or disclosures, or associations together with disclosures not known to the relevant art prior to the present invention but provided by the invention. Some of such contributions of the invention may be specifically pointed out below, whereas other such contributions of the invention will be apparent from their context.

A large number of communication devices used in communication systems are portable. Thus, efficient power saving schemes have been developed to increase the operating times of portable battery-powered devices. In radio systems, discontinuous reception DRX is one of the schemes developed partly for these purposes.

In discontinuous reception, a portable device receives data periodically at specific reception intervals. At other, idle intervals, the device does not receive. In prior art, the system determines the duration of DRX and idle periods.

The communication system may set up the DRX of a mobile device or user equipment UE to save the battery power when it estimates that the UE need not receive transmission from a base station in every radio sub frame. The algorithms used to control the DRX are generally vendor specific. The communication system has neither any knowledge about the applications that are being run in the UE nor any knowledge about the actions of the end user. The network estimation of the near future air interface activity is thus based only on the most recent air interface traffic history. Furthermore, only the history of the present session is available. The fundamental problem is that there are no other means to predict the future traffic than to assume that the on-going traffic activity and pattern will go on without changes.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided an apparatus in a communication system, comprising: at least one processor; and at least one memory including computer program code, the at least one memory and the computer program code configured to, with the at least one processor, cause the apparatus at least to perform: execute one or more applications, which generate data traffic with the system; obtain information related to traffic profiles of the one or more applications; control the transmission of information related to the traffic profiles to the communication system.

According to an aspect of the present invention, there is provided a method in a communication system, comprising: executing one or more applications, which generate data traffic with the system; obtaining information related to the traffic profiles of the one or more applications; controlling the transmission of information related to the traffic profiles to the communication system.

According to an aspect of the present invention, there is provided an apparatus in a communication system, comprising: at least one processor; and at least one memory including computer program code, the at least one memory and the computer program code configured to, with the at least one processor, cause the apparatus at least to perform: communicate with user equipment; receive from the user equipment information related to the traffic profiles of one or more applications running in the user equipment; utilise the received information when controlling the discontinued transmission of the user equipment.

According to an aspect of the present invention, there is provided a method in a communication system, comprising: receiving from the user equipment information related to the traffic profiles of one or more applications running in the user equipment; utilising the received information when controlling the discontinued transmission of the user equipment.

### LIST OF DRAWINGS

Embodiments of the present invention are described below, by way of example only, with reference to the accompanying drawings, in which

FIG. 1 illustrates an example of a communication environment;

FIG. 2 illustrates an example of an apparatus applying embodiments of the invention;

FIG. 3 is a flowchart illustrating embodiments of the invention;

FIG. 4 illustrates an example of the architecture of the apparatus;

FIGS. 5A and 5B are flowcharts illustrating embodiments of the invention; and

FIG. 6 illustrates an example of an apparatus applying embodiments of the invention.

### DESCRIPTION OF SOME EMBODIMENTS

Embodiments are applicable to any base station, user equipment (UE), server, corresponding component, and/or to any communication system or any combination of different communication systems that support required functionality.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

Many different radio protocols to be used in communications systems exist. Some examples of different communication systems are the universal mobile telecommunications system (UMTS) radio access network (UTRAN or E-UTRAN), long term evolution (LTE, known also as E-UTRA), long term evolution advanced (LTE-A), Wireless Local Area Network (WLAN) based on IEEE 802.11 standard, worldwide interoperability for microwave access (WiMAX), Bluetooth®, personal communications services (PCS) and systems using ultra-wideband (UWB) technology. IEEE refers to the Institute of Electrical and Electronics Engineers. LTE and LTE-A are developed by the Third Generation Partnership Project 3GPP.

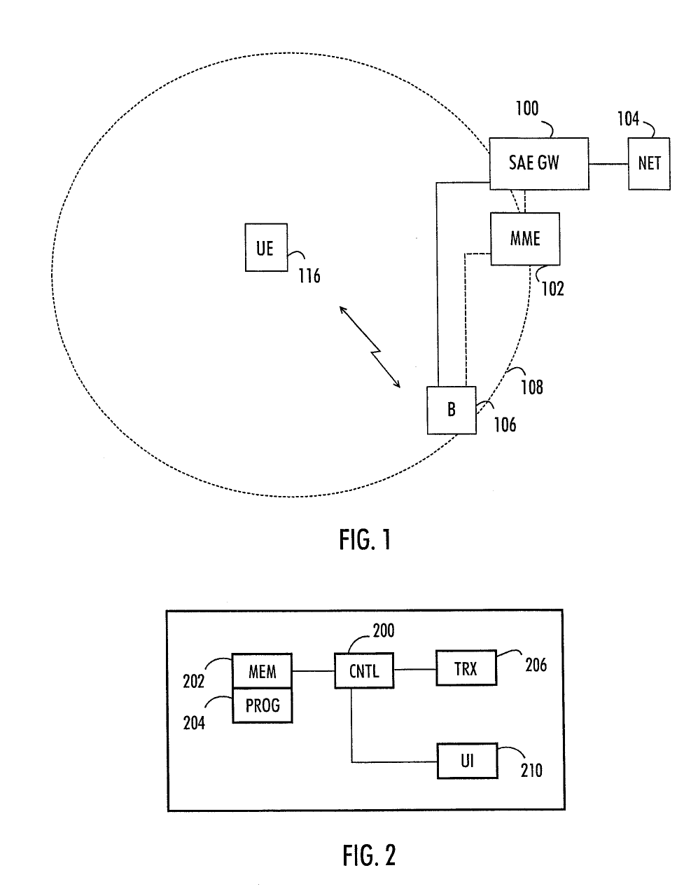

FIG. 1 illustrates a simplified view of a communication environment only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for communication are irrelevant to the actual invention. Therefore, they need not to be discussed in more detail here.

In the example of FIG. 1, a radio system based on LTE/SAE (Long Term Evolution/System Architecture Evolution) network elements is shown. However, the embodiments described in these examples are not limited to the LTE/SAE radio systems but can also be implemented in other radio systems.

The simplified example of a network of FIG. 1 comprises a SAE Gateway 100 and an MME 102. The SAE Gateway 100 provides a connection to Internet 104. FIG. 1 shows an eNodeB 106 serving a cell 108. In this example, the eNodeB 106 is connected to the SAE Gateway 100 and the MME 102.

In the example of FIG. 1, user equipment UE 116 is camped on the eNodeB 106.

The eNodeBs (Enhanced node Bs) of a communication system may host the functions for Radio Resource Management: Radio Bearer Control, Radio Admission Control, Connection Mobility Control, Dynamic Resource Allocation (scheduling). The MME 102 (Mobility Management Entity) is responsible for the overall UE control in mobility, session/call and state management with assistance of the eNodeBs through which the UEs connect to the network. The SAE GW 100 is an entity configured to act as a gateway between the network and other parts of communication network such as the Internet for example. The SAE GW may be a combination of two gateways, a serving gateway (S-GW) and a packet data network gateway (P-GW).

User equipment UE refers to a portable computing device. Such computing devices include wireless mobile communication devices operating with or without a subscriber identification module (SIM), including, but not limited to, the following types of devices: mobile phone, smartphone, personal digital assistant (PDA), tablet computer, laptop computer.

For example, in universal mobile telecommunications system (UMTS) radio access network (UTRAN or E-UTRAN), the DRX system is a relatively flexible having two levels, the short and the long DRX. Normally UE receives Physical Downlink Control Channel PDCCH transmission from a base station in every sub frame. When UE is in DRX, it does not receive PDCCH. The interval of the PDCCH reception is relatively short in the “short mode” and significantly longer in the “long mode”. This method was developed to tackle the fact that the nature of a typical Internet access is such that Internet Protocol IP packets are sent in bursts.

In other words, it is typical that several messages are sent and received with very short intervals at times and there are rather long pauses between these “bursts” of messages. The E-UTRAN DRX is in its “long mode” when no messages are transmitted. It enters the “short mode” when a message is received. It stays in the “short mode” as long as more messages are received at short enough intervals. The DRX system returns to the “long mode” when a configured maximum time has passed after the reception of the last message.

Modern communication systems are designed using layered architecture protocols, where similar communications functions are placed in similar layers. One of the key principles of the layered architecture of the communications protocols is that the layers are independent of each other. The lower layer does not know (and is not interested in) the contents of a packet an upper layer submits for delivery. In a similar way, the upper layer does not know (and is not interested in) the way the lower layer delivers the packet. This architectural principle is a very important one to guarantee the robustness and ease of maintenance of the communications systems, but it may also be a problem in optimizing the efficiency of the protocols. In some cases the lower layer would benefit from knowing the nature of the data being delivered. This problem is present in the control of DRX.

For example, in EUTRAN when the system controls the short mode and long mode DRX it is not able to take into account the specific needs of the applications running in the UEs. It must base the control overall traffic activity of the UE in recent past.

FIG. 2 illustrates an embodiment. The figure illustrates a simplified example of a device in which embodiments of the invention may be applied. In some embodiments, the device may be user equipment UE or a respective device communicating with a base station or an eNodeB of a communications system.

It should be understood that the apparatus is depicted herein as an example illustrating some embodiments. It is apparent to a person skilled in the art that the device may also comprise other functions and/or structures and not all described functions and structures are required. Although the device has been depicted as one entity, different modules and memory may be implemented in one or more physical or logical entities.

The device of the example includes a control circuitry 200 configured to control at least part of the operation of the device.

The device may comprise a memory 202 for storing data. Furthermore the memory may store software 204 executable by the control circuitry 200. The memory may be integrated in the control circuitry.

The device comprises a transceiver 206. The transceiver is operationally connected to the control circuitry 200. It may be connected to an antenna arrangement (not shown).

The software 204 may comprise a computer program comprising program code means adapted to cause the control circuitry 200 of the device to control a transceiver 206.

The device may further comprise user interface 210 operationally connected to the control circuitry 200. The user interface may comprise a display which may be touch sensitive, a keyboard or keypad, a microphone and a speaker, for example.

The control circuitry 200 is configured to execute one or more applications. The applications may be stored in the memory 202. The applications may generate data traffic with the system. The applications may require data from a server in the Internet or they may store data in a server. In general the traffic generated by applications may be periodic or continuous or something in between.

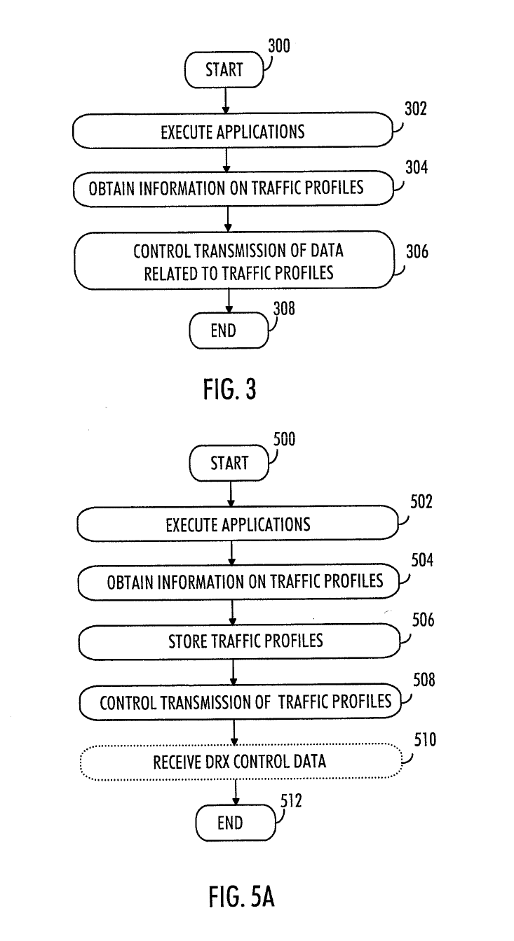

FIG. 3 is a flowchart illustrating an embodiment of the invention. The embodiment starts at step 300.

In step 302, the apparatus is configured to execute one or more applications, which generate data traffic with the system.

In step 304, the apparatus is configured to obtain information related the traffic profiles of the one or more applications. The information may be received from the applications or it may be obtained by analysing the data traffic of the applications.

In step 306, the apparatus is configured to control the transmission of information related to the traffic profiles to the communication system.

The process ends in step 308.

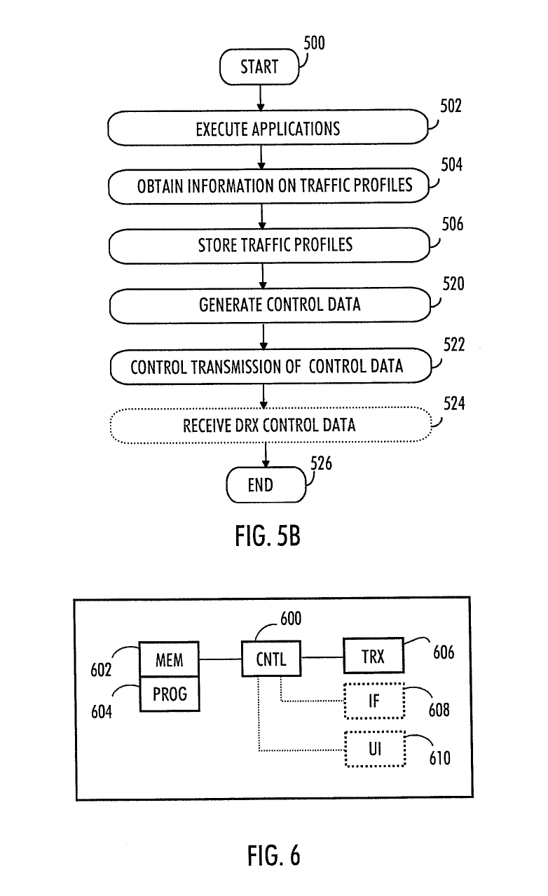

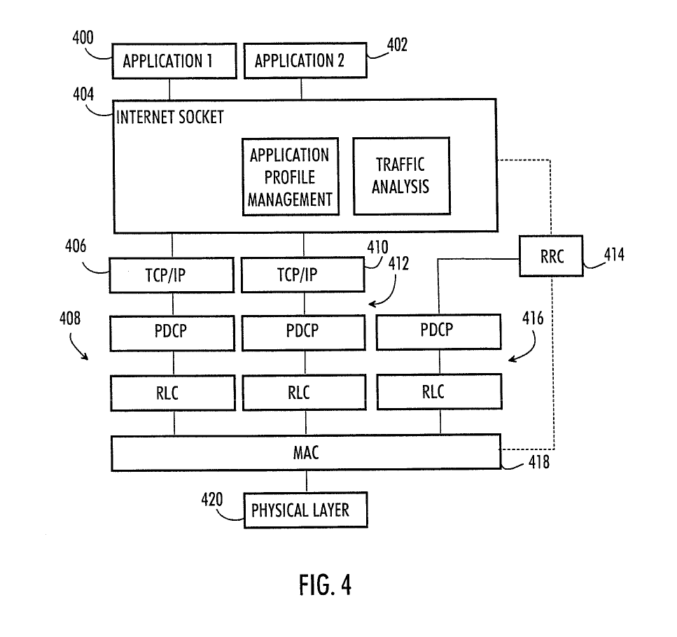

FIG. 4 illustrates an embodiment of the invention. The figure illustrates an example of the architecture of user equipment. In an embodiment, this architecture is realized by the controller 200, memory 202 and transceiver 206, for example. In this example the user equipment is running two applications 400, 402 at the same time. The applications that use the Internet access are connected to the Internet Socket 404 which, in turn, is connected to the Radio Access Network (RAN) protocol stack via the Transmission Control Protocol/Internet Protocol TCP/IP protocol stack. Each application has its own TPC/IP protocol stack 406, 408 and RAN protocol stack 410, 412. The Radio Resource Control RRC 414 takes care of the DRX configurations and the related signalling between the UE and the base station or eNodeB through its own RAN protocol stack 416. The architecture further comprises Medium Access Control MAC 418 and physical layer 420.

The TCP/IP protocol stack typically comprises Packet data convergence protocol PDCP and Radio link control RLC.

In prior art, the Internet Socket 404 is configured to act as an interface between the applications and the communications protocol stacks 406 to 412. In an embodiment, the Internet Socket is further configured to manage the traffic profiles of each application. The Internet Socket may be configured to receive from the applications information whether the way an application transmits the IP packets is regular in such a way that the information of the characteristics of the transmission might be useful in radio protocol optimization. The obtained information may be denoted the traffic profile of each application.

All the applications are not able to send their traffic profile even if they had a very regular way of communicating. In an embodiment, the Internet Socket comprises traffic analysis functionality which analyses the statistics of the traffic of each application and identifies useful regularities and obtains a traffic profile for each application. Independent of whether the traffic profiles were obtained from the applications directly or by the way of traffic analysis or both the traffic profile of each application may be stored in memory.

In an embodiment, the traffic profile information of the Internet Socket 404 is used for DRX optimization. The Internet Socket forwards the traffic profile information to the RRC 414 as soon as it is available. If the traffic profile is already stored in a memory or the application tells the profile information with the application interface of the socket, the parameters for the DRX optimization can already be signalled to the eNodeB along the corresponding bearer setup. If the Socket needs to analyse the traffic, the DRX optimization information is given as soon as it is ready. In an embodiment, the traffic profiles may be updated if the analysis finds new features or if the traffic profile changes over time. The traffic profiles are reported via RRC 414 so that they are handled together with the corresponding logical channels. Thus the eNodeB can associate each set of traffic profiles of each application to the logical channels and the eNodeB can get synchronized to the starting points of the profiles.

The DRX settings in the MAC are common to all logical channels, so the system has to combine the pieces of information and work out the most optimal DRX setup for the combination of the applications. It is signalled via RRC using existing procedures.

In an embodiment, the eNodeB may grant uplink resources to the UE at or near the expected uplink activity if there is free uplink capacity available on the PUSCH even if the UE does not always have anything to send at that grant. Thus, the UE need not always start the transmission of the packets with a random access RA procedure.

In an embodiment, the Internet Socket is configured to recognize mode changes in the applications or the applications may themselves update the traffic profile information if there are changes. In addition, the Internet Socket is configured to inform the eNodeB with RRC signalling if one of the communicating applications is closed.

Above, the application profile management and the traffic analysis have been placed in the Internet Socket. However, it is also possible to place them in other parts of the architecture, most notably in RRC, PDCP, RLC, and MAC, and the functionalities can also be distributed to several parts.

FIG. 5A is another flowchart illustrating an embodiment of the invention in user equipment apparatus. The embodiment starts at step 500.

In step 502, an apparatus is configured to execute one or more applications, which generate data traffic with the system.

In step 504, the apparatus is configured to obtain the traffic profiles of the one or more applications. The profiles may be received from the applications or they may be obtained by analysing the data traffic of the applications.

In an embodiment, the applications may send several parameters to the Internet Socket. The parameters may comprise a mode indicator which indicates whether the traffic is expected to be periodic, mostly periodic, or not periodic. In addition, the expected period of the messages (receptions or transmissions) may be included. The expected period may be longer than the typical short DRX value range (helps in determining the long DRX period). If the traffic is not periodic, the value indicates an estimate of the typical shortest time between the messages or traffic bursts, because the long DRX setting would be determined according to that.

In addition, the estimated length of the traffic bursts may be included. This helps in determining the short DRX configuration. The value 0 indicates that the traffic is not bursty.

Furthermore, the expected spacing between the messages during a traffic burst may be included. This value helps in determining the short DRX configuration. It may be a dummy value when the previous value is 0.

In step 506, the apparatus is configured to store the traffic profiles of the one or more applications.

In step 508, the apparatus is configured to control the transmission of the traffic profiles to the communication system.

In step 510, the apparatus may be configured to receive DRX control data from the eNodeB. The eNodeB has processed the information sent by the apparatus and decided the DRX operation on the basis of the information. The operation of the eNodeB is explained later.

The process ends in step 512.

FIG. 5B is another flowchart illustrating an embodiment of the invention in user equipment apparatus. The embodiment starts at step 500. The first steps 502 to 506 are similar to the example of FIG. 5A.

In step 502, an apparatus is configured to execute one or more applications, which generate data traffic with the system.

In step 504, the apparatus is configured to obtain the traffic profiles of the one or more applications. The profiles may be received from the applications or they may be obtained by analysing the data traffic of the applications.

In step 506, the apparatus is configured to store the traffic profiles of the one or more applications.

In step 520, the apparatus is configured to determine parameters for DRX control on the basis of the traffic profiles.

In step 522, the apparatus is configured to control the transmission of the DRX parameters to the communication system.

In step 524, the apparatus may be configured to receive DRX control data from the eNodeB. The eNodeB has processed the information sent by the apparatus and perform the DRX control on the basis of the information.

The process ends in step 526.

Thus, the processing of traffic profile data of the applications may be performed either in the UE or in the network side of the communication system.

The UE may determine the DRX settings itself on the basis of the traffic profiles and propose the DRX settings to the eNodeB using the same format as is used by the eNodeB when it sends the DRX configuration to the UE. This is a good alternative if the UE has some more knowledge about the nature of the application than can be expressed with the parameters mentioned above, i.e. the UE may be able to determine a more optimal DRX configuration that the eNodeB can.

On the other hand, the UE may send the parameters received by the Internet Socket as such to the eNodeB. This is a good option in the sense that some information may be lost because of the granularity of the DRX configuration signalling. The eNodeB may be able to optimize the common DRX configuration better for the coexisting applications when the traffic properties are expressed with a better resolution than the one used in the DRX configuration signalling.

The information may be signalled using either RRC signalling or MAC level signalling.

Next, an example of a method that the Internet Socket may apply for estimating a traffic profile of an application on the basis of traffic generated by the application is disclosed. However, it is to be noted that the disclosed method is merely an example of various solutions which may be applied. Other different methods may be used as well. Here it is assumed that the traffic generated by one or more applications running in user equipment comprises Internet Protocol packets. In general, the Internet Socket analyses the timing of the Internet Protocol packets transmitted by the applications.

The disclosed method (and possibly other methods as well) do not necessarily use one pass algorithms only, so it is often necessary to store the time stamps of all the received and transmitted messages for some time for later use. With this stored history record, it is possible to analyse some features of the traffic timing after some other parameters are ready. For instance, it is not possible to determine the number of message intervals exceeding the average interval before calculating the average.

All time parameter, variables, etc. are expressed in sub frames, which in E-UTRA is milliseconds. Other time units can be used equally well.

Let t(i), i=1, 2, 3, . . . , M, be the time stamps of the messages. The intervals between the successive messages are thus

d(i)=t(i+1)−t(i), i=1, 2, 3, . . . , M−1

In the example algorithm, a histogram of inter-message times is created. (step 1). It is smoothed by filtering it with a rectangular window of size 2K+1 (step 3). The histogram is an estimate of the probability density function of the interval between successive messages. Then the periodicity of the traffic is estimated by finding the first major peak of the histogram, ignoring the short intervals and low peaks (steps 2, 4, and 6). The shorter intervals are taken as intra-burst intervals (step 5). The degree of periodicity is estimated by working out the frequency of the remaining interval lengths (steps 7 . . . 10). The maximum burst length is determined by adding up successive short periods (steps 11 . . . 14).

1. Set h(i)=0 for all i=0, 1, 2, 3, . . . , N

2. For i=1, 2, 3, . . . , M−1, let h(d(i))←h(d(i))+1

3. g(i)=Σ_{j=i-K}^{i+K}h(i+j), i=0, 1, 2, 3, . . . , N, with h(a)=0 if a<0

4. G=C1*max g(i), C1<1, i=C2, C2+1, C2+2, . . . , N

5. Find the index p of the first local maximum g(p) in g(j) with j=0, 1, 2, 3, . . . , C2−1

6. Find the index q of the first local maximum g(q) in g(j) with j=C2, C2+1, C2+2, . . . , N so that g(q)>G, but if such a local maximum does not exist, report that the traffic is not periodic and go to step 11

7. Calculate the sum R of h(k) where k=p+K+1, p+K+2, . . . , q−K−2, q−K−1, q+K+1, q+K+2, . . . , N

8. If R<C3, report that the traffic is periodic

9. If C3<=R<C4, report that the traffic is mostly periodic

10. If R>=C4, report that the traffic is not periodic

11. If d(1)<p+C5, b(1)=d(1), else b(1)=0

12. If d(i)<p+C5, b(i)=b(i−1)+d(i), else b(i)=0, i=2, 3, 4, . . . , M−1

13. B=max b(i), i=1, 2, 3, . . . , M−1

14. Report B as the burst length

15. If B>0, report p as the spacing between messages during the traffic burst.

16. If the traffic has been reported as periodic or mostly periodic, report q+B as the expected period of the messages.

Above, C1, C2, C3, C4, N and M are predetermined constants which may be determined on the basis of the system applying the embodiments.

Some of the points in the above algorithm may be varied as one skilled in the art is aware. For instance, the periodicity can easily be estimated using the autocorrelation function.

FIG. 6 illustrates an embodiment. The figure illustrates a simplified example of a device in which embodiments of the invention may be applied. In some embodiments, the device may be a base station or an eNodeB of a communications system.

It should be understood that the device is depicted herein as an example illustrating some embodiments. It is apparent to a person skilled in the art that the device may also comprise other functions and/or structures and not all described functions and structures are required. Although the device has been depicted as one entity, different modules and memory may be implemented in one or more physical or logical entities.

The device of the example includes a control circuitry 600 configured to control at least part of the operation of the device.

The device may comprise a memory 602 for storing data. Furthermore the memory may store software 604 executable by the control circuitry 600. The memory may be integrated in the control circuitry.

The device comprises a transceiver 606. The transceiver is operationally connected to the control circuitry 600. It may be connected to an antenna arrangement (not shown).

The software 604 may comprise a computer program comprising program code means adapted to cause the control circuitry 600 of the device to control a transceiver 606 to communicate with and control user equipment.

The device may further comprise interface circuitry 608 configured to connect the device to other devices and network elements of a communication system, for example to core. This applies especially if the device is an eNodeB or a base station or respective network element. The interface may provide a wired or wireless connection to the communication network. The device may be in connection with core network elements, eNodeB's, Home NodeB's and with other respective devices of communication systems.

The device may further comprise user interface 610 operationally connected to the control circuitry 600. The user interface may comprise a display, a keyboard or keypad, a microphone and a speaker, for example.

In an embodiment, the control circuitry 600 is configured to control the device to receive from user equipment traffic profile information on applications running in the user equipment. The circuitry is configured to determine DRX control utilising the received information. The control circuitry 600 is configured to control the transmission of DRX related information to the user equipment.

The device may be configured to receive parameters for discontinued transmission control from user equipment and control the transmission of DRX related information to the user equipment.

The device may be configured to receive traffic of the one or more applications running in the user equipment each in its own logical channel, and receive the information related to the traffic profiles of each application in the corresponding logical channel. Traffic received from of the one or more applications running in the user equipment may comprise Internet Protocol packets, in which case the traffic profiles may comprise information related to the timing of the packets.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, or a circuitry which may comprise a working memory (RAM), a central processing unit (CPU), and a system clock. The CPU may comprise a set of registers, an arithmetic logic unit, and a controller. The controller or the circuitry is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

In an embodiment, there is provided a computer program product embodied on a distribution medium readable by a computer and comprising program instructions which, when loaded into an apparatus, execute the steps of: executing one or more applications, which generate data traffic with the system; obtaining information related to traffic profiles of the one or more applications and controlling the transmission of information related to the traffic profiles to the communication system.

In an embodiment, there is provided a computer program product embodied on a distribution medium readable by a computer and comprising program instructions which, when loaded into an apparatus, execute the steps of: receiving from the user equipment information related to the traffic profiles of one or more applications running in the user equipment and utilising the received information when controlling the discontinued transmission of the user equipment.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst a number of computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

In an embodiment, there is provided an apparatus in a communication system, comprising: means for executing one or more applications, which generate data traffic with the system; means for obtaining information related to traffic profiles of the one or more applications; means for controlling the transmission of information related to the traffic profiles to the communication system.

In an embodiment, there is provided an apparatus in a communication system, comprising: means for receiving from the user equipment information related to the traffic profiles of one or more applications running in the user equipment; means for utilising the received information when controlling the discontinued transmission of the user equipment.

It will be obvious to a person skilled in the art that, as technology advances, the inventive concept can be implemented in various ways. The invention and its embodiments are not limited to the examples described above but may vary within the scope of the claim.

1. An apparatus in a communication system, comprising:
at least one processor; and
at least one memory including computer program code,
the at least one memory and the computer program code configured to, with the at least one processor, cause the apparatus at least to perform:
execute one or more applications, which generate data traffic with the system;
obtain information related to traffic profiles of the one or more applications;
control the transmission of information related to the traffic profiles to the communication system.

2. The apparatus of claim 1, the apparatus being configured to
receive information on the traffic profile of an application from the application.

3. The apparatus of claim 1, the apparatus being configured to
determine and/or update the traffic profile of an application by analysing the traffic generated by the application.

4. The apparatus of claim 1, the apparatus being configured to store the traffic profiles of the one or more applications.

5. The apparatus of claim 1, the apparatus being configured to determine parameters for discontinued transmission control on the basis of the traffic profiles; and
transmit the parameters to the communication system.

6. The apparatus of claim 1, the apparatus being configured to transmit the traffic profiles to the communication system.

7. The apparatus of claim 1, the apparatus being configured to analyse the timing of Internet Protocol packets transmitted by one or more applications.

8. The apparatus of claim 1, the apparatus being configured to store traffic profile comprising the mode of the traffic, the mode having one of following values: periodic, mostly periodic and not periodic.

9. The apparatus of claim 1, the apparatus being configured to
transmit the traffic of the one or more applications each in its own logical channel, and
transmit to the communication system the information related to the traffic profile of each application using the corresponding logical channel.

10. The apparatus of claim 1, the apparatus being configured to transmit information related to the traffic profiles along a bearer setup request.

11. An apparatus in a communication system, comprising:
at least one processor; and
at least one memory including computer program code,
the at least one memory and the computer program code configured to, with the at least one processor, cause the apparatus at least to perform:
communicate with user equipment;
receive from the user equipment information related to the traffic profiles of one or more applications running in the user equipment;
utilise the received information when controlling the discontinued transmission of the user equipment.

12. The apparatus of claim 11, the apparatus being configured to receive parameters for discontinued transmission control from user equipment.

13. The apparatus of claim 11, the apparatus being configured to receive the traffic profiles of one or more applications from user equipment.

14. A method in a communication system, comprising:
executing one or more applications, which generate data traffic with the system;
obtaining information related to the traffic profiles of the one or more applications;
controlling the transmission of information related to the traffic profiles to the communication system.

15. The method of claim 14, further comprising: receiving information on the traffic profile of an application from the application.

16. The method of claim 14, further comprising: determining and/or updating the traffic profile of an application by analysing the traffic generated by the application.

17. The method of claim 14, further comprising:
storing the traffic profiles of the one or more applications.

18. The method of claim 14, further comprising: determining parameters for discontinued transmission control on the basis of the traffic profiles; and
transmitting the parameters to the communication system.

19. The method of claim 14, further comprising: transmitting the traffic profiles to the communication system.

20. The method of claim 14, further comprising: analysing the timing of Internet Protocol packets transmitted by one or more applications.

21. The method of claim 14, further comprising: storing traffic profile comprising the mode of the traffic, the mode having one of following values: periodic, mostly periodic and not periodic.

22. The method of claim 14, further comprising:
transmitting the traffic of the one or more applications each in its own logical channel, and
transmitting to the communication system the information related to the traffic profile of each application using the corresponding logical channel.

23. A method in a communication system, comprising:
receiving from the user equipment information related to the traffic profiles of one or more applications running in the user equipment;
utilising the received information when controlling the discontinued transmission of the user equipment.

24. The method of claim 23, further comprising: receiving parameters for discontinued transmission control from user equipment.

25. The method of claim 23, further comprising: receiving the traffic profiles of one or more applications from user equipment.
